(19) United States
(12) Patent Application Publication
(10) Pub. No.: US 2010/0317358 A1
(43) Pub. Date: Dec. 16, 2010

(54) RECEIVING APPARATUS, BASE STATION APPARATUS, AND SYNCHRONIZATION TIMING DETECTION METHOD

(75) Inventor: Toshiro SAWAMOTO, Kawasaki (JP)

Correspondence Address: MYERS WOLIN, LLC, 100 HEADQUARTERS PLAZA, North Tower, 6th Floor, MORRISTOWN, NJ, 07960-6834, US

(73) Assignee: FUJITSU LIMITED, Kawasaki-shi (JP)

(21) Appl. No.: 12/813,124

(22) Filed: Jun. 10, 2010

(30) Foreign Application Priority Data
Jun. 16, 2009 (JP) 2009143271

(51) Int. Cl. H04W 72/04; H04B 7/005; H04B 17/00

(52) U.S. Cl. 455/450; 455/226.1; 455/67.11

(57) ABSTRACT

A receiving apparatus includes a synchronization timing detector that detects one of a first sampling timing and a second sampling timing as a synchronization timing of a received digital signal. The first sampling timing being a timing at which a maximum correlation power value is detected and the second sampling timing being a timing adjacent to the first sampling timing. The detecting is based on a correlation power value detected at the first sampling timing, a correlation power value detected at the second sampling timing, a correlation power value detected at a third sampling timing that precedes an earlier one of the first and the second sampling timing by n sampling intervals, and a correlation power value detected at a fourth sampling timing that follows a later one of the first and the second sampling timing by n sampling intervals, where n is a natural number.

### CROSS-REFERENCE TO RELATED APPLICATIONS

This application is based upon and claims the benefit of priority of the prior Japanese Patent Application No. 2009-143271, filed on Jun. 16, 2009, the entire contents of which are incorporated herein by reference.

### FIELD

The present invention relates to a technique for allowing a receiving apparatus that receives a radio signal to detect a synchronization timing of the received signal.

### BACKGROUND

Some receiving apparatuses that receive a radio signal detect a maximum correlation power value between the received signal and a reference code sequence corresponding to the received signal, and detect a synchronization timing of the received signal. Examples of such receiving apparatuses include a receiving apparatus that uses a spread spectrum method. For example, in the Wideband Code Division Multiple Access (W-CDMA) method or the like, a base station apparatus collectively receives transmission signals transmitted simultaneously from a plurality of mobile station apparatuses, and separates received data for each mobile station apparatus. In order to separate data received from a certain mobile station apparatus, the base station apparatus performs a de-spreading process on the received data using a spreading code uniquely assigned to the certain mobile station apparatus, and thus extracts the data transmitted from the certain mobile station apparatus. In this case, the base station apparatus detects a timing at which a maximum correlation power value between the spreading code and the received data is obtained, and thus obtains a synchronization timing between the received data and the spreading code.

Japanese Laid-open Patent Publication No. 09-64857 proposes a maximum correlation value timing estimation circuit including an input signal sampling means for sampling an input signal with given sampling periods and outputting a sampled sequence signal, a correlating means for performing cross-correlation calculation between the sampled sequence signal and a reference sequence signal and outputting a correlation value, and a maximum correlation value timing estimating means for estimating a timing at which a maximum correlation is obtained, with an accuracy less than or equal to the given sampling periods, using a determination result based on the magnitude relationship between correlation values obtained during a given search period. The maximum correlation value timing estimating means estimates a timing at which a maximum correlation is obtained, using a maximum correlation value during the search period, at least two correlation values obtained before and after the maximum correlation value, a first determination value for determining the basic magnitudes of the above at least three correlation values, and a second determination value for determining the magnitude relationship between two correlation values among the at least three correlation values.

Japanese Laid-open Patent Publication No. 2004-96230 proposes a spread spectrum signal receiving apparatus including a de-spreading processing unit that de-spreads a received digital signal having a first sampling rate at a given de-spreading timing using a spreading code sequence.

The spread spectrum signal receiving apparatus includes a decimation processing unit that performs a decimation process on the received signal to obtain a decimated signal having a second sampling rate lower than the first sampling rate, a correlation value obtaining unit that sequentially de-spreads the decimated signal using a corresponding spreading code sequence at individual timings of the second sampling rate to obtain correlation values, and a de-spreading timing determination unit that determines, based on a correlation value obtained at a timing at which a peak correlation value is obtained and a correlation value obtained at a timing preceding or subsequent to the timing at which the peak correlation value is obtained, a de-spreading timing as a timing of the first sampling rate which is later than the preceding timing and which is earlier than the subsequent timing. The de-spreading timing determination unit determines the de-spreading timing based on the ratio of a pre-peak difference to a post-peak difference. The pre-peak difference is a difference between the correlation value obtained at the timing preceding the timing at which the peak correlation value is obtained and the correlation value obtained at the timing at which the peak correlation value is obtained. The post-peak difference is a difference between the correlation value obtained at the timing at which the peak correlation value is obtained and the correlation value obtained at the timing subsequent to the timing at which the peak correlation value is obtained.

When correlation power values are computed using digital signal processing, the resolution of the synchronization timing determined based on the correlation power values depends upon the sampling rate and/or the number of quantization bits. That is, the higher the sampling rate and/or the larger the number of quantization bits, the more accurately a synchronization timing is detected. However, an increase in sampling rate and the number of quantization bits may lead to an increase in circuit size and an increase in the amount of processing. In the design, therefore, the sampling rate and/or the number of quantization bits may be determined with consideration of the tradeoff among the resolution of the synchronization timing, the circuit size, and the amount of processing.

The reason that the accuracy of detecting a synchronization timing by detecting a maximum value of correlation power values is low when the sampling rate is low and the number of quantization bits is small will now be described. FIG. 1 is a diagram depicting an impulse response signal of a filter before quantization. The impulse response signal exhibits a maximum value at a peak time tp between time t1 and time t2.

It is assumed that the impulse response signal is sampled at sampling timings ts. Since the sampling timings ts are discrete times, an error occurs between the time t1 at which the maximum value is obtained among the signal values obtained at the sampling timings ts and the peak time tp of the original impulse response signal. The lower the sampling rate, the larger the error.

Before the quantization of the impulse response signal, there is a difference between the signal value obtained at the time t1 and the signal value obtained at the time t2 (the time t1 and the time t2 are hereinafter also referred to as the “sampling timing t1” or “timing t1” and the “sampling timing t2” or “timing t2”, respectively) if the true peak time tp is close to one of the sampling timings t1 and t2. In the above example, since the true peak time tp is closer to the sampling timing t1, the signal value obtained at the sampling timing t1 is larger than the signal value obtained at the sampling timing t2. In this manner, before the quantization of the impulse response signal, the signal values obtained at the sampling timings t1 and t2 are compared, and the timing at which the larger signal value is detected is selected. Thus, the sampling timing that is closest to the true peak time tp is selected.

FIG. 2 is a diagram depicting an impulse response signal of a filter after quantization. In this state, due to the quantization, the signal values obtained at the sampling timings t1 and t2 are the same, that is, a value I1. Thus, it is difficult to determine which of the sampling timings t1 and t2 is closer to the true peak time tp. The smaller the number of quantization bits, the more it is difficult to distinguish the magnitudes of signal values. Therefore, it is difficult to determine which of the two sampling timings between which the true peak time tp exists, that is, the sampling timings t1 and t2, is closer to the true peak time tp. Consequently, there is a larger error between a peak time selected from among the sampling timings is and the peak time tp of the original signal.

Accordingly, due to a reduction in sampling rate and the number of quantization bits, there may be a large error between a peak time detected from a sampled and quantized signal and a true peak time tp of the original signal. When a maximum value of correlation power values is detected, similarly, a reduction in sampling rate and the number of quantization bits may cause an increased difference between the time at which the maximum value of the correlation power values quantized is detected and the true synchronization timing. This may result in a reduction in the accuracy of detecting a synchronization timing.

### SUMMARY

According to an aspect of the invention, a receiving apparatus includes a demodulator that demodulates a received signal into a baseband signal, an analog-to-digital converter that oversamples the baseband signal to convert signal values of the baseband signal, which are obtained at individual sampling timings, into multi-level codes, a correlation value detector that detects correlation power values between a sequence of multi-level codes of a received digital signal obtained by an analog-to-digital conversion process performed by the analog-to-digital converter and a reference code sequence, and a synchronization timing detector that detects one of a first sampling timing and a second sampling timing as a synchronization timing of the received digital signal, the first sampling timing being a timing at which a maximum correlation power value is detected by the correlation value detector and the second sampling timing being a timing adjacent to the first sampling timing, based on a correlation power value detected at the first sampling timing, a correlation power value detected at the second sampling timing, a correlation power value detected at a third sampling timing that precedes an earlier one of the first sampling timing and the second sampling timing by n sampling intervals, and a correlation power value detected at a fourth sampling timing that follows a later one of the first sampling timing and the second sampling timing by n sampling intervals, where n is a natural number.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram depicting an impulse response signal of a filter before quantization.

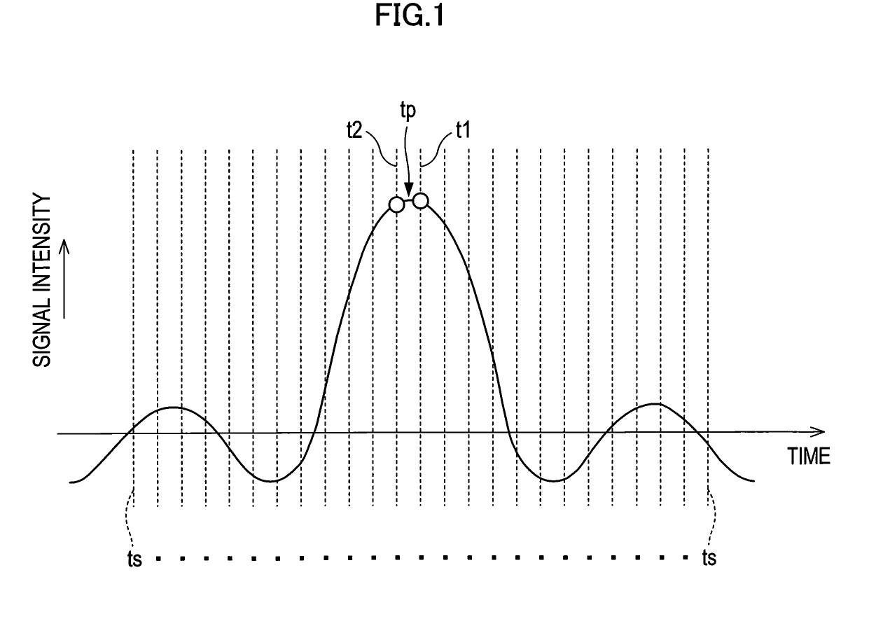

FIG. 2 is a diagram depicting an impulse response signal of a filter after quantization.

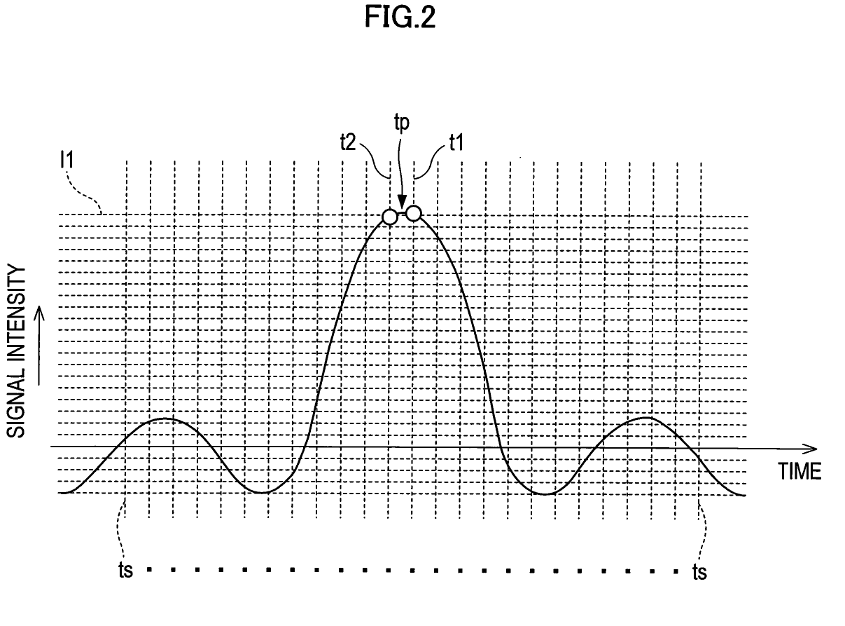

FIG. 3 is a diagram illustrating a first example of a receiving apparatus.

FIG. 4 is a graph illustrating a delay profile that is based on correlation power values.

FIG. 5 is a diagram describing a first example of the process of a synchronization timing detection method.

FIG. 6 is a diagram describing a first example of the synchronization timing detection method.

FIG. 7 is a diagram describing a second example of the process of a synchronization timing detection method.

FIG. 8 is a diagram describing a second example of the synchronization timing detection method.

FIG. 9 is a diagram illustrating a communication system including a second example of a receiving apparatus.

### DESCRIPTION OF THE PREFERRED EMBODIMENTS

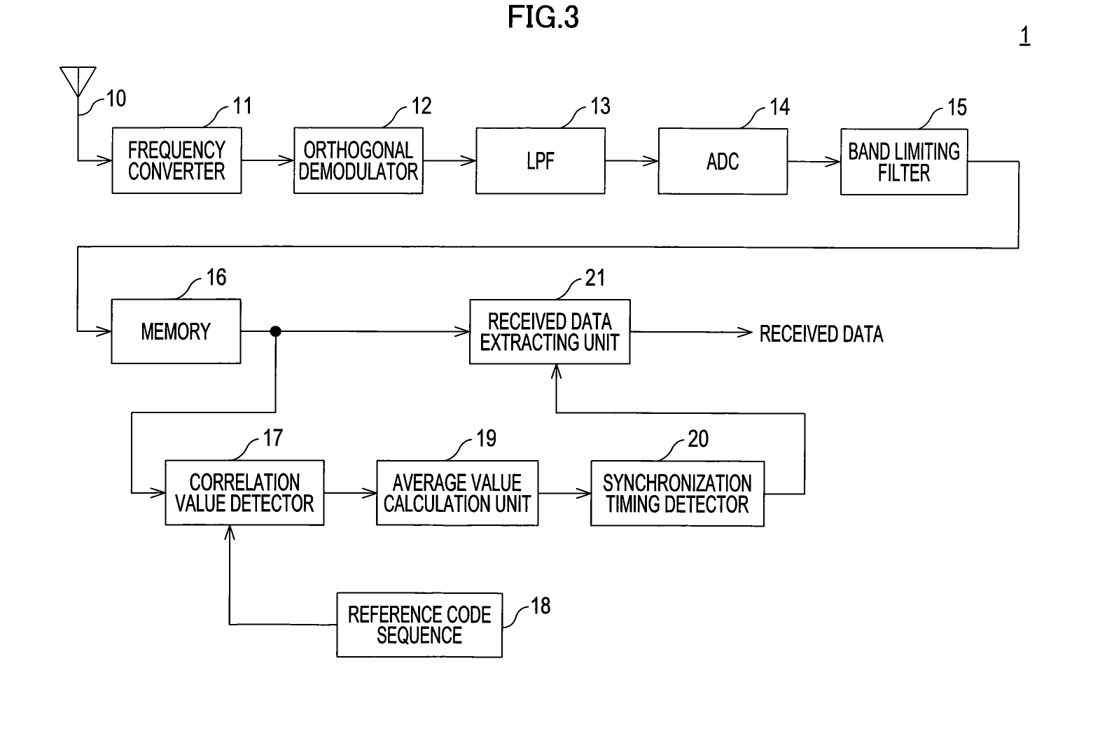

FIG. 3 is a diagram illustrating a first example of a receiving apparatus. Reference numeral 1 denotes a receiving apparatus; reference numeral 10 denotes an antenna; reference numeral 11 denotes a frequency converter; and reference numeral 12 denotes an orthogonal demodulator. Reference numeral 13 denotes a low-pass filter (LPF); reference numeral 14 denotes an analog-to-digital converter (ADC); reference numeral 15 denotes a band limiting filter; and reference numeral 16 denotes a memory. Reference numeral 17 denotes a correlation value detector; reference numeral 18 denotes a reference code sequence; reference numeral 19 denotes an average value calculation unit; reference numeral 20 denotes a synchronization timing detector; and reference numeral 21 denotes a received data extracting unit.

The receiving apparatus 1 includes the antenna 10, the frequency converter 11, the orthogonal demodulator 12, the low-pass filter 13, the analog-to-digital converter 14, the band limiting filter 15, and the memory 16. The receiving apparatus 1 further includes the correlation value detector 17, the average value calculation unit 19, the synchronization timing detector 20, and the received data extracting unit 21.

The frequency converter 11 converts a radio-frequency signal received by the antenna 10 into an intermediate-frequency signal. The orthogonal demodulator 12 demodulates the intermediate-frequency signal output from the frequency converter 11 into a baseband signal of the in-phase component (I-channel component) and the orthogonal component (quadrature or Q-channel component). The low-pass filter 13 limits the bandwidth of the output signal of the orthogonal demodulator 12.

The analog-to-digital converter 14 samples the baseband signal filtered by the low-pass filter 13 at a sampling rate higher than the chip rate of the baseband signal output from the orthogonal demodulator 12. In the following description with respect to an example of the receiving apparatus 1, it is assumed that the sampling rate of the analog-to-digital converter 14 is four times as high as the chip rate of the baseband signal output from the orthogonal demodulator 12. However, this example is not limited to an embodiment in which the above sampling rate is used. The analog-to-digital converter 14 may also use other sampling rates.

In the following description with respect to the example of the receiving apparatus 1, furthermore, the term “sampling timing” refers to a sampling timing with the sampling rate of the analog-to-digital converter 14 unless otherwise stated. The analog-to-digital converter 14 outputs multi-level codes indicating the values of the baseband signal filtered by the low-pass filter 13, which are obtained at the individual sampling timings. In the following description with respect to the example of the receiving apparatus 1, a digital signal into which the baseband signal is converted by the analog-to-digital converter 14 is also referred to as a “received digital signal.”

The band limiting filter 15 is a digital filter that removes the frequency components other than a desired frequency range from the received digital signal output from the analog-to-digital converter 14. The received digital signal obtained using filtering by the band limiting filter 15 is stored in the memory 16.

The correlation value detector 17 reads the received digital signal stored in the memory 16. The correlation value detector 17 calculates, for each sampling timing tᵢ, a correlation power value C(tᵢ) between the reference code sequence 18 and the multi-level code sequence of the received digital signal read from the memory 16. In this case, the correlation value detector 17 calculates a correlation power value C(tᵢ) for each sampling timing tᵢ by shifting the multi-level code sequence of the received digital signal, for which the correlation power value C(tᵢ) is to be determined with respect to the reference code sequence 18, by one sample. The change in the correlation power values C(tᵢ) calculated over such a plurality of different sampling timings is referred to as a “delay profile.”

Here, the reference code sequence 18 is the same code sequence as a synchronization detection code sequence that is given at known positions in the received signal for use in synchronization detection. For example, when a spread spectrum modulation method is used, the reference code sequence 18 may be a spreading code sequence that is used to perform spread spectrum processing by a transmitter that has transmitted a signal to be received by the receiving apparatus 1. The correlation value detector 17 may calculate a correlation power value C(tᵢ) using, for example, Equation (1) as follows:

$$C ( {t}_{i} ) = {\sum }_{j - i}^{L} \{ {[ a ( {t}_{( i + 4 \times j )} ) \times {I}_{j} ]}^{2} + {[ b ( {t}_{( j + 4 \times j )} ) \times {Q}_{j} ]}^{2} \} \qquad ( 1 )$$

where a(t_{i+4×j)}) (j=1, 2 . . . ) represents each multi-level code of the received digital signal of the I-channel component, and b(t(_{i+4×j)}) represents each multi-level code of the received digital signal of the Q-channel component. In Equation (1), Iⱼ represents a reference code used for the I-channel component, and Qⱼ represents a reference code used for the Q-channel component. Further, L represents the number of bits of the original reference code.

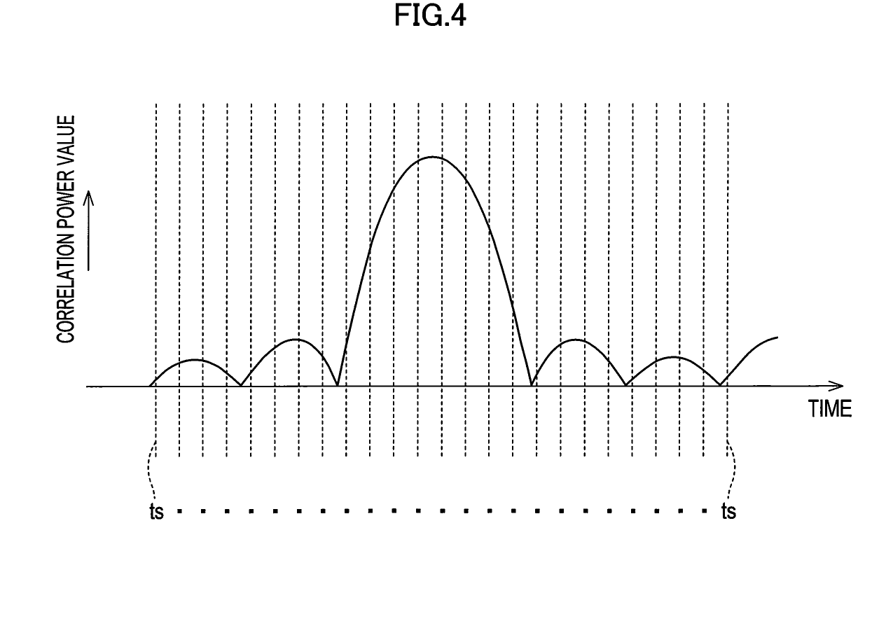

FIG. 4 is a graph illustrating a delay profile that is based on the correlation power values C(tᵢ). The delay profile exhibits a peak at the time when the synchronization detection code sequence included in the received signal is synchronized with the reference code sequence 18. As illustrated in FIG. 4, in the vicinity of the peak, the delay profile has a shape in which the gradient of the delay profile increases as it moves away from the peak. Further, in the vicinity of the peak, the delay profile has a symmetrical waveform.

The above waveform results from an impulse response of the filter used by the transmitter that has transmitted a signal to be received by the receiving apparatus 1 in order to limit the frequency bandwidth of the signal. Examples of a filter having such an impulse response include a roll-off filter such as a root roll-off filter.

The average value calculation unit 19 calculates an average value of correlation power values calculated by the correlation value detector 17 at a plurality of sampling timings having the same intervals as the periods during which the synchronization detection code sequence appears in the received signal. The synchronization timing detector 20 detects a sampling timing at which the average value of correlation power values output from the average value calculation unit 19 becomes maximum, and notifies the received data extracting unit 21 of the detected timing as the synchronization timing of the received signal. The process of determining a synchronization timing using the synchronization timing detector 20 will be described in more detail below.

The received data extracting unit 21 extracts desired received data from the received digital signal stored in the memory 16 in accordance with the notified synchronization timing.

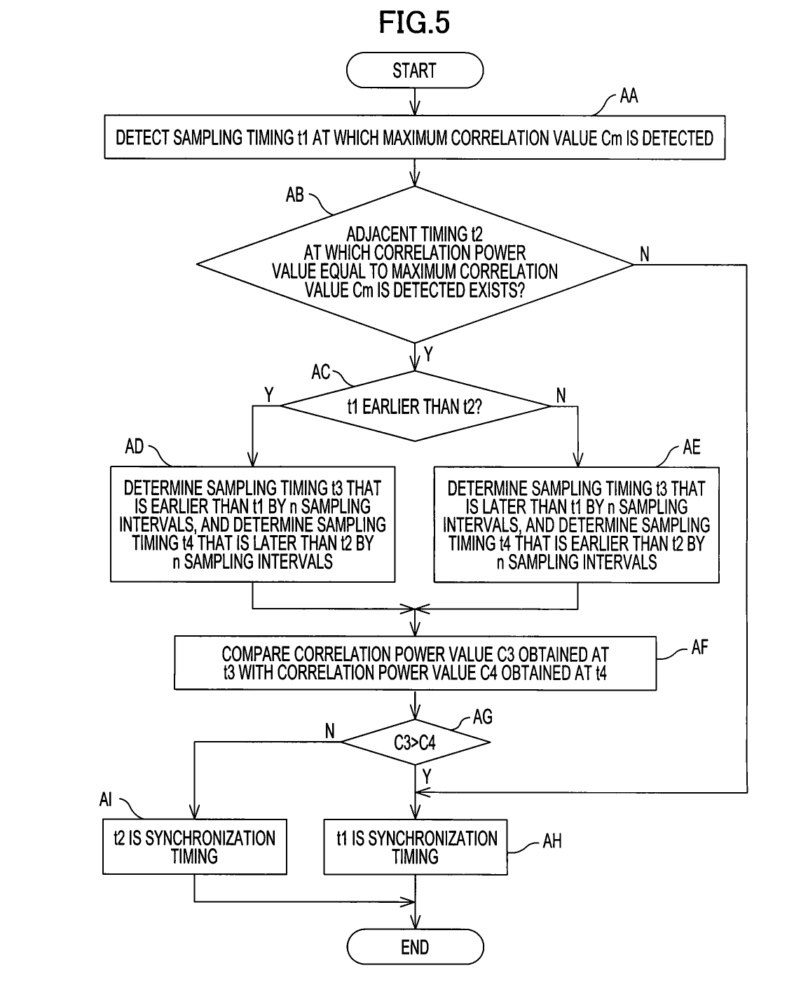

Subsequently, a first example of the process of the synchronization timing detection method executed by the synchronization timing detector 20 will be described. FIG. 5 is a diagram describing the first example of the process of the synchronization timing detection method. In another embodiment, operations in Operations AA to AI described below may be implemented as steps. In the following description with respect to the example of the receiving apparatus 1, the average value of correlation power values input from the average value calculation unit 19 is referred to simply as a “correlation power value.”

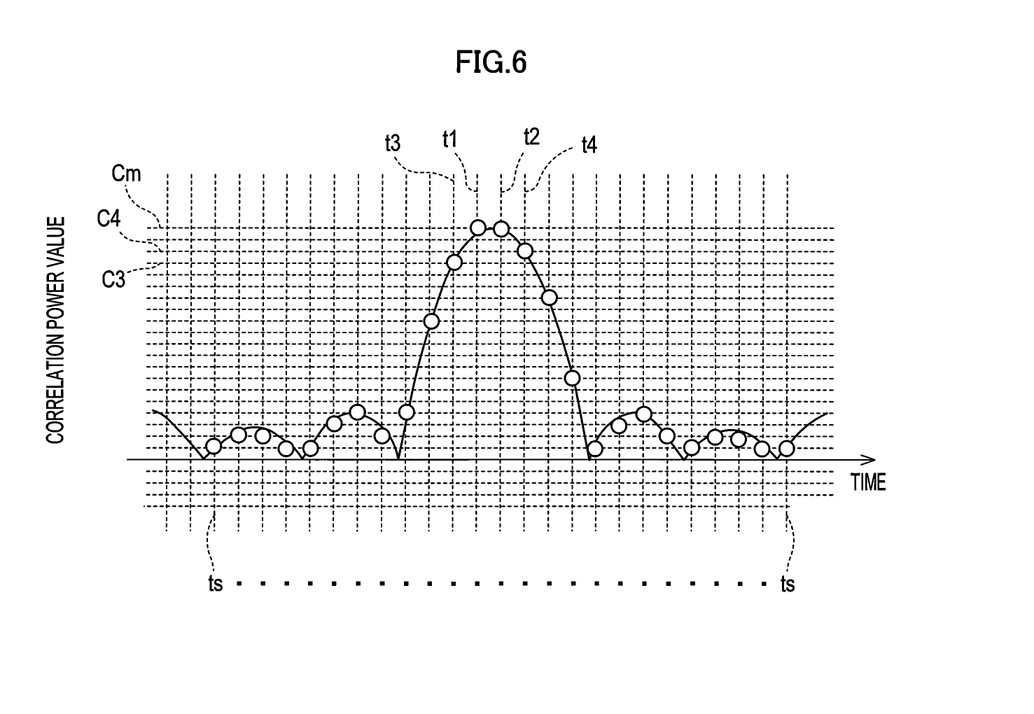

In Operation AA, the synchronization timing detector 20 detects a sampling timing t1 at which a maximum correlation value Cm, which is the maximum value of the correlation power values sequentially input from the average value calculation unit 19, is detected. FIG. 6 is a diagram depicting a first example of the synchronization timing detection method, and illustrates a waveform of correlation power values. In FIG. 6, vertical dotted lines represent sampling timings ts, and horizontal dotted lines represent discrete values that quantized correlation power values may take.

For example, when a peak value higher than a certain threshold value is detected, the synchronization timing detector 20 may detect the detected peak value as the maximum correlation value Cm. Further, for example, the synchronization timing detector 20 may detect the first to J-th peaks within a search period while shifting the search period, detect the peak values of the first to J-th peaks as the maximum correlation values Cm thereof, and perform the following process to determine J multipath synchronization timings.

In Operation AB, the synchronization timing detector 20 determines whether or not one of the sampling timings adjacent to the timing t1 is a timing t2 at which a correlation power value equal to the maximum correlation value Cm is detected. When a correlation power value equal to the maximum correlation value Cm is detected at an adjacent sampling timing (YES in Operation AB), the synchronization timing detector 20 advances the process to Operation AC. When a correlation power value equal to the maximum correlation value Cm is not detected at an adjacent sampling timing (NO in Operation AB), the synchronization timing detector 20 advances the process to Operation AH.

In Operation AC, the synchronization timing detector 20 determines whether or not the timing t1 is earlier than the adjacent timing t2. When the timing t1 is earlier than the timing t2 (YES in Operation AC), the synchronization timing detector 20 advances the process to Operation AD. When the timing t1 is later than the timing t2 (NO in Operation AC), the synchronization timing detector 20 advances the process to Operation AE.

In Operation AD, the synchronization timing detector 20 determines that the timing that is earlier than the timing t1 by n sampling intervals is a timing t3, and further determines that the timing that is later than the timing t2 by n sampling intervals is a timing t4, where n is a natural number. An example of the set timings t3 and t4 is illustrated in FIG. 6. In this example, n is set to “1”. The timing t3 is a timing that is earlier than the timing t1 by one sampling interval, and the timing t4 is a timing that is later than the timing t2 by one sampling interval. Then, the synchronization timing detector 20 advances the process to Operation AF. In an actual implementation, the value n may be set to a desired value in accordance with the waveform of correlation power values or the oversampling rate.

In Operation AE, the synchronization timing detector 20 determines that the timing that is later than the timing t1 by n sampling intervals is a timing t3. The synchronization timing detector 20 further determines that the timing that is earlier than the timing t2 by n sampling intervals is a timing t4. Then, the synchronization timing detector 20 advances the process to Operation AF.

In Operation AF, the synchronization timing detector 20 compares the correlation power value C3 obtained at the timing t3 with the correlation power value C4 obtained at the timing t4. As described above, in the vicinity of a peak, the gradient of the waveform of correlation power values increases as it moves away from the peak. Therefore, the difference between the correlation power values C3 and C4 obtained at the timings t3 and t4, which are adjacent to the timings t1 and t2, respectively, is larger than the difference between the correlation power values obtained at the timings t1 and t2, and a difference may be likely to occur even in a quantized version.

Here, the waveform of correlation power values is symmetrical with respect to the peak. Thus, if the correlation power value C3 obtained at the timing t3 that is outside the timing t1 is larger than the correlation power value C4 obtained at the timing t4 that is outside the timing t2, it is determined that the timing t1 is closer to the true synchronization timing. Conversely, if the correlation power value C3 is not larger than the correlation power value C4, it is determined that the timing t2 is closer to the true synchronization timing.

Therefore, when the correlation power value C3 is larger than the correlation power value C4 (YES in Operation AG), the synchronization timing detector 20 advances the process to Operation AH, and determines that the timing t1 is a synchronization timing. Similar processing is performed when it is determined in Operation AB that the adjacent timing t2 does not exist (NO in Operation AB). Then, the synchronization timing detector 20 ends the process.

When the correlation power value C3 is not larger than the correlation power value C4 (NO in Operation AG), the synchronization timing detector 20 advances the process to Operation AI, and determines that the timing t2 is a synchronization timing. Then, the synchronization timing detector 20 ends the process.

In the state illustrated in FIG. 6, the maximum correlation value Cm is detected at both the timings t1 and t2 (YES in Operation AB). Since the correlation power value C4 obtained at the timing t4 is larger than the correlation power value C3 obtained at the timing t3 (NO in Operation AG), it is determined that the timing t2 is closer to the true synchronization timing.

According to the present embodiment, when the maximum correlation value Cm is detected at the plurality of sampling timings t1 and t2, it is possible to determine which of the sampling timings t1 and t2 is closer to the optimum synchronization timing. Thus, the accuracy of detecting a synchronization timing may be increased.

Further, since the present embodiment may be implemented by adding the process as described above to the process of detecting a synchronization timing, the implementation is made available without increasing the circuit size, which may be caused by increasing the sampling rate or the number of quantization bits. In addition, the increase in the amount of processing is much less significant than the increase in the amount of processing caused by increasing the sampling rate or the number of quantization bits.

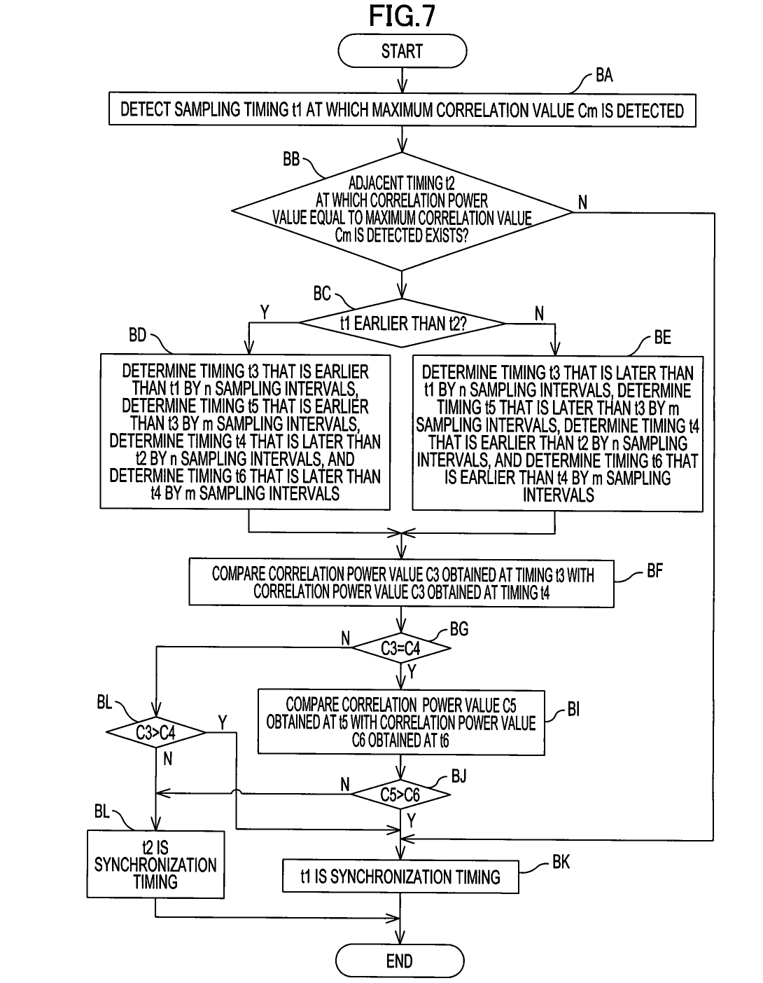

FIG. 7 is a diagram describing a second example of the process of the synchronization timing detection method. In another embodiment, operations in Operations BA to BL described below may be implemented as steps.

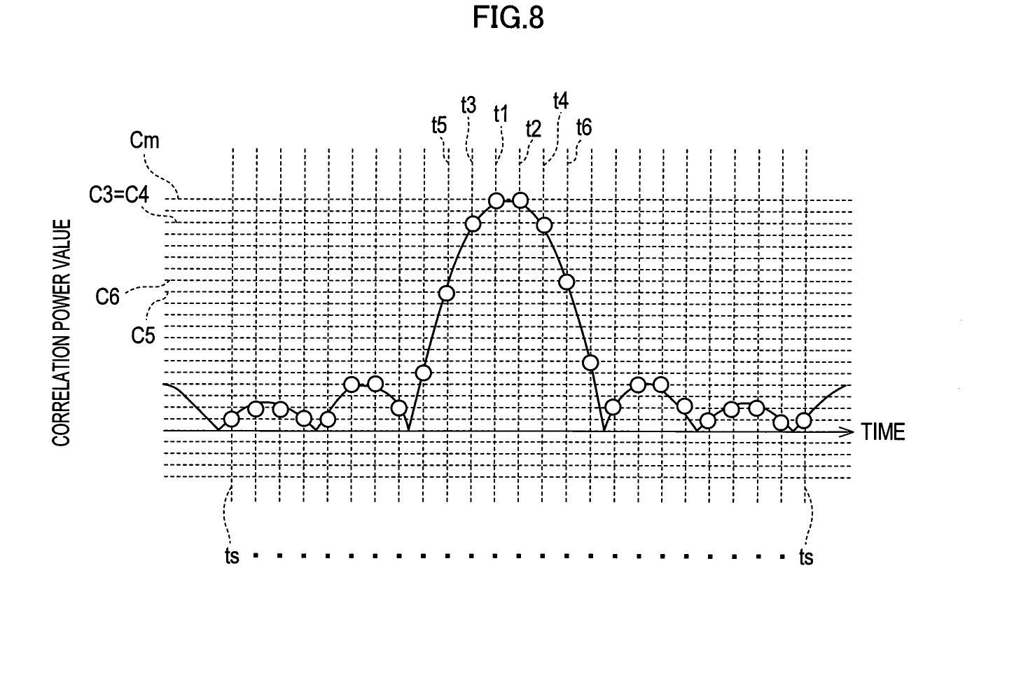

In Operation BA, the synchronization timing detector 20 detects a sampling timing t1 at which a maximum correlation value Cm, which is the maximum value of the correlation power values sequentially input from the average value calculation unit 19, is detected. The synchronization timing detector 20 may detect the sampling timing t1 using processing similar to that of Operation AA in FIG. 5. FIG. 8 is a diagram describing a second example of the synchronization timing detection method, and illustrates a waveform of correlation power values. In FIG. 8, vertical dotted lines represent sampling timings ts, and horizontal dotted lines represent discrete values that quantized correlation power values may take.

In Operation BB, the synchronization timing detector 20 determines whether or not one of the sampling timings adjacent to the timing t1 is a timing t2 at which a correlation power value equal to the maximum correlation value Cm is detected. When a correlation power value equal to the maximum correlation value Cm is detected at an adjacent sampling timing (YES in Operation BB), the synchronization timing detector 20 advances the process to Operation BC. When a correlation power value equal to the maximum correlation value Cm is not detected at an adjacent sampling timing (NO in Operation BB), the synchronization timing detector 20 advances the process to Operation BK.

In Operation BC, the synchronization timing detector 20 determines whether or not the timing t1 is earlier than the adjacent timing t2. When the timing t1 is earlier than the timing t2 (YES in Operation BC), the synchronization timing detector 20 advances the process to Operation BD. When the timing t1 is later than the timing t2 (NO in Operation BC), the synchronization timing detector 20 advances the process to Operation BE.

In Operation BD, the synchronization timing detector 20 determines that the timing that is earlier than the timing t1 by n sampling intervals is a timing t3, and further determines that the timing that is earlier than the timing t3 by m sampling intervals is a timing t5, where m and n are natural numbers. In this example, m and n are set to “1”. In an actual implementation, the values m and n may be set to desired values in accordance with the waveform of correlation power values or the oversampling rate.

Further, the synchronization timing detector 20 determines that the timing that is later than the timing t2 by n sampling intervals is a timing t4, and also determines that the timing that is later than the timing t4 by m sampling intervals is a timing t6. An example of the set timings t3 to t6 is illustrated in FIG. 6. The timing t3 is a timing that is earlier than the timing t1 by one sampling interval, and the timing t5 is a timing that is earlier than the timing t3 by one sampling interval. The timing t4 is a timing that is later than the timing t2 by one sampling interval, and the timing t6 is a timing that is later than the timing t4 by one sampling interval. Then, the synchronization timing detector 20 advances the process to Operation BF.

In Operation BE, the synchronization timing detector 20 determines that the timing that is later than the timing t1 by n sampling intervals is a timing t3. The synchronization timing detector 20 further determines that the timing that is later than the timing t3 by m sampling intervals is a timing t5. Further, the synchronization timing detector 20 determines the timing that is earlier than the timing t2 by n sampling intervals is a timing t4. The synchronization timing detector 20 determines that the timing that is earlier than the timing t4 by m sampling intervals is a timing t6. Then, the synchronization timing detector 20 advances the process to Operation BF.

In Operation BF, the synchronization timing detector 20 compares the correlation power value C3 obtained at the timing t3 with the correlation power value C4 obtained at the timing t4. When the correlation power value C3 is not equal to the correlation power value C4 (NO in Operation BG), the synchronization timing detector 20 advances the process to Operation BH. When the correlation power value C3 is equal to the correlation power value C4 (YES in Operation BG), the synchronization timing detector 20 advances the process to Operation BI.

Further, when the correlation power value C3 is larger than the correlation power value C4 (YES in Operation BH), the synchronization timing detector 20 advances the process to Operation BK, and determines that the timing t1 is a synchronization timing. Similar processing is performed when it is determined in Operation BB that the adjacent timing t2 does not exit (NO in Operation BB). Then, the synchronization timing detector 20 ends the process.

When the correlation power value C3 is not larger than the correlation power value C4 (NO in Operation BH), the synchronization timing detector 20 advances the process to Operation BL, and determines that the timing t2 is a synchronization timing. Then, the synchronization timing detector 20 ends the process.

On the other hand, in Operation BI, the synchronization timing detector 20 compares the correlation power value C5 obtained at the timing t5 with the correlation power value C6 obtained at the timing t6. As described above, in the vicinity of a peak, the gradient of the waveform of correlation power values increases as it moves away from the peak. Therefore, the difference between the correlation power values C5 and C6 obtained at the timings t5 and t6, which are adjacent to the timings t3 and t4, respectively, is larger than the difference between the correlation power values obtained at the timings t3 and t4, and a difference may be likely to occur even in a quantized version.

Further, if the correlation power value C5 obtained at the timing t5 that is outside the timing t1 is larger than the correlation power value C6 obtained at the timing t6 that is outside the timing t2, it is determined that the timing t1 is closer to the true synchronization timing. Conversely, if the correlation power value C5 is not larger than the correlation power value C6, it is determined that the timing t2 is closer to the true synchronization timing.

Therefore, when the correlation power value C5 is larger than the correlation power value C6 (YES in Operation BJ), the synchronization timing detector 20 advances the process to Operation BK, and determines that the timing t1 is a synchronization timing. Then, the synchronization timing detector 20 ends the process. When the correlation power value C5 is not larger than the correlation power value C6 (NO in Operation BJ), the synchronization timing detector 20 advances the process to Operation BL, and determines that the timing t2 is a synchronization timing. Then, the synchronization timing detector 20 ends the process.

According to the present embodiment, even when there is no difference between the correlation power values obtained at the timings t3 and t4 described above or the difference therebetween is small, it may possible to determine which of the timings t1 and t2 is closer to the optimum synchronization timing by comparing the correlation power values obtained at the timings t5 and t6 that are outside the timings t1 and t2.

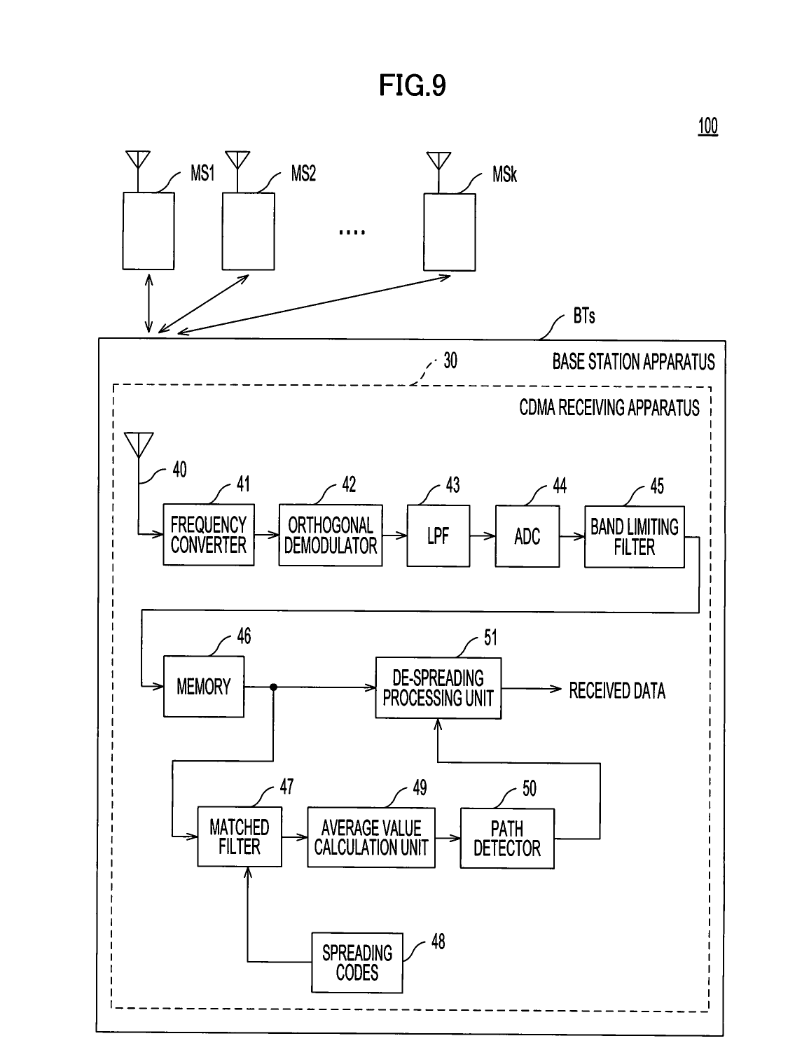

FIG. 9 is a diagram illustrating a communication system including a second example of a receiving apparatus. Reference numeral 100 denotes a communication system; reference BTS denotes a base station apparatus; and reference MS1, MS2, . . . , and MSk denote mobile station apparatuses. Reference numeral 30 denotes a CDMA receiving apparatus; reference numeral 40 denotes an antenna; reference numeral 41 denotes a frequency converter; reference numeral 42 denotes an orthogonal detector; and reference numeral 43 denotes a low-pass filter (LPF).

Reference numeral 44 denotes an analog-to-digital converter (ADC); reference numeral 45 denotes a band limiting filter; reference numeral 46 denotes a memory; and reference numeral 47 denotes a matched filter. Reference numeral 48 denotes spreading codes; reference numeral 49 denotes an average value calculation unit; reference numeral 50 denotes a path detector; and reference numeral 51 denotes a de-spreading processing unit.

The communication system 100 includes the base station apparatus BTS, and the plurality of mobile station apparatuses MS1, MS2, . . . , and MSk. The base station apparatus BTS includes the CDMA receiving apparatus 30 that receives a signal obtained by multiplexing transmission signals from the plurality of mobile station apparatuses MS1 to MSk using the CDMA method.

The CDMA receiving apparatus 30 includes the antenna 40, the frequency converter 41, the orthogonal detector 42, the low-pass filter 43, the analog-to-digital converter 44, the band limiting filter 45, and the memory 46. The receiving apparatus 30 further includes the matched filter 47, the average value calculation unit 49, the path detector 50, and the de-spreading processing unit 51.

The frequency converter 41 converts a radio-frequency signal received by the antenna 40 into an intermediate-frequency signal. The orthogonal detector 42 demodulates the intermediate-frequency signal output from the frequency converter 41 into a baseband signal having a chip rate. The baseband signal includes in-phase component data, or I-channel component data, and orthogonal component data, or Q-channel data. The low-pass filter 43 limits the bandwidth of the output signal of the orthogonal detector 42.

The analog-to-digital converter 44 samples the baseband signal filtered by the low-pass filter 43 at a sampling rate higher than the chip rate of the baseband signal. Further, in the following description with respect to an example of the CDMA receiving apparatus 30, the term “sampling timing” refers to a sampling timing with the sampling rate of the analog-to-digital converter 44 unless otherwise stated. The analog-to-digital converter 44 outputs multi-level codes indicating the values of the baseband signal filtered by the low-pass filter 43, which are obtained at the individual sampling timings. In the following description with respect to the example of the CDMA receiving apparatus 30, a digital signal into which the baseband signal is converted by the analog-to-digital converter 44 is also referred to as a “received digital signal.”

The band limiting filter 45 is a digital filter that removes the frequency components other than a desired frequency range from the received digital signal output from the analog-to-digital converter 44. The received digital signal obtained using filtering by the band limiting filter 45 is stored in the memory 46.

The matched filter 47 reads the received digital signal stored in the memory 46. The matched filter 47 calculates, for each sampling timing tᵢ, a correlation power value between the sequence of spreading codes 48 and a multi-level code sequence of the received digital signal, which is read from the memory 46. The matched filter 47 may calculate a correlation power value given by, for example, Equation (1) above. Each frame of the received signal includes a pilot signal including the same code as the corresponding one of the spreading codes 48. Each time the code sequence of the received signal input to the matched filter 47 matches the sequence of spreading codes 48, the matched filter 47 outputs a maximum value.

The average value calculation unit 49 calculates an average value of correlation power values calculated by the matched filter 47 at a plurality of sampling timings having the same intervals as the frame periods of the received signal. The path detector 50 detects a path timing at which the average value of correlation power values output from the average value calculation unit 49 becomes maximum, and notifies the de-spreading processing unit 51 of the detected path timing. The process of detecting a maximum average value of the correlation power values and detecting a path timing using the path detector 50 is similar to the process of determining a synchronization timing using the synchronization timing detector 20 described above.

The de-spreading processing unit 51 performs a de-spreading process by multiplying the received digital signal read from the memory 46 by the spreading codes in accordance with the path timing notified by the path detector 50. The path detector 50 may repeat a process similar to the synchronization timing determination process performed by the synchronization timing detector 20 on each of a plurality of multiple paths, and detect a path timing for each of the paths.

A spreading code is determined for each of the mobile station apparatuses MS1 to MSk. The de-spreading processing unit 51 multiples the received digital signal by the individual spreading codes to separate the user data received from the mobile station apparatuses MS1 to MSk from the received digital signal. The matched filter 47, the average value calculation unit 49, and the path detector 50 detect a path timing for each of the mobile station apparatuses MS1 to MSk.

In the example of the CDMA receiving apparatus 30 described above, after analog-to-digital conversion is performed on a received signal, received signals from the plurality of mobile station apparatuses MS1 to MSk are separated. This may not allow discrete sampling timings to be adjusted to the true path timing by shifting the shift sampling timings for individual mobile station apparatuses. In a path timing detection method according to the present embodiment, a sampling timing that is closer to the true path timing is selected without changing the sampling timings in analog-to-digital conversion. Therefore, it is possible to execute the path timing detection method on each of the plurality of mobile station apparatuses MS1 to MSk.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

1. A receiving apparatus comprising:
a demodulator that demodulates a received signal into a baseband signal;
an analog-to-digital converter that oversamples the baseband signal to convert signal values of the baseband signal, which are obtained at individual sampling timings, into multi-level codes;
a correlation value detector that detects correlation power values between a sequence of the multi-level codes and a reference code sequence; and
a synchronization timing detector that detects one of a first sampling timing and a second sampling timing as a synchronization timing of the received digital signal, the first sampling timing being a timing at which a maximum correlation power value is detected by the correlation value detector and the second sampling timing being a timing adjacent to the first sampling timing, wherein
the detecting is based on a correlation power value detected at the first sampling timing, a correlation power value detected at the second sampling timing, a correlation power value detected at a third sampling timing that precedes an earlier one of the first sampling timing and the second sampling timing by n sampling intervals, and a correlation power value detected at a fourth sampling timing that follows a later one of the first sampling timing and the second sampling timing by n sampling intervals, where n is a natural number.

2. The receiving apparatus according to claim 1, wherein the synchronization timing detector selects one of the first sampling timing and the second sampling timing in accordance with a result of comparison between the correlation power value detected at the third sampling timing and the correlation power value detected at the fourth sampling timing.

3. The receiving apparatus according to claim 1, wherein the synchronization timing detector detects one of the first sampling timing and the second sampling timing in accordance with a result of comparison between the correlation power value detected at the third sampling timing and the correlation power value detected at the fourth sampling timing when the correlation power value detected at the first sampling timing is equal to the correlation power value detected at the second sampling timing.

4. The receiving apparatus according to claim 3, wherein the synchronization timing detector detects one of the first sampling timing and the second sampling timing as the synchronization timing based on the correlation power value detected at the first sampling timing, the correlation power value detected at the second sampling timing, the correlation power value detected at the third sampling timing, the correlation power value detected at the fourth sampling timing, a correlation power value detected at a fifth sampling timing that precedes the third sampling timing by m sampling intervals, and a correlation power value detected at a sixth sampling timing that follows the fourth sampling timing by m sampling intervals, where m is a natural number.

5. The receiving apparatus according to claim 4, wherein the synchronization timing detector detects one of the first sampling timing and the second sampling timing in accordance with a result of comparison between the correlation power value detected at the fifth sampling timing and the correlation power value detected at the sixth sampling timing when the correlation power value detected at the third sampling timing is equal to the correlation power value detected at the fourth sampling timing.

6. The receiving apparatus according to claim 1, wherein the synchronization timing detector detects one of the first sampling timing and the second sampling timing as the synchronization timing based on the correlation power value detected at the first sampling timing, the correlation power value detected at the second sampling timing, the correlation power value detected at the third sampling timing, the correlation power value detected at the fourth sampling timing, a correlation power value detected at a fifth sampling timing that precedes the third sampling timing by m sampling intervals, and a correlation power value detected at a sixth sampling timing that follows the fourth sampling timing by m sampling intervals, where m is a natural number.

7. A base station apparatus comprising:
a receiving apparatus including
a demodulator that demodulates a received signal into a baseband signal,
an analog-to-digital converter that oversamples the baseband signal to convert signal values of the baseband signal, which are obtained at individual sampling timings, into multi-level codes,
a correlation value detector that detects correlation power values between a sequence of the multi-level codes and a reference code sequence, and
a synchronization timing detector that detects one of a first sampling timing and a second sampling timing as a synchronization timing of the received digital signal, the first sampling timing being a timing at which a maximum correlation power value is detected by the correlation value detector and the second sampling timing being a timing adjacent to the first sampling timing, wherein
the synchronization timing detector detects one of the first sampling timing and the second sampling timing based on a correlation power value detected at the first sampling timing, a correlation power value detected at the second sampling timing, a correlation power value detected at a third sampling timing that precedes an earlier one of the first sampling timing and the second sampling timing by n sampling intervals, and a correlation power value detected at a fourth sampling timing that follows a later one of the first sampling timing and the second sampling timing by n sampling intervals, where n is a natural number.

8. The base station apparatus according to claim 8, wherein the synchronization timing detector detects a synchronization timing of each of signals received from a plurality of mobile communication apparatuses, the signals being included in the received digital signal.

9. A synchronization timing detection method comprising:
demodulating a received signal into a baseband signal;
oversampling the baseband signal to convert signal values of the baseband signal, which are obtained at individual sampling timings, into multi-level codes, thereby generating a received digital signal including a multi-level code sequence including the multi-level codes;
detecting correlation power values between the multi-level code sequence of the received digital signal and a reference code sequence; and
detecting one of a first sampling timing and a second sampling timing as a synchronization timing of the received digital signal, the first sampling timing being a timing at which a maximum value of the correlation power values is detected by the correlation value detector and the second sampling timing being a timing adjacent to the first sampling timing, wherein the detecting is based on a correlation power value detected at the first sampling timing, a correlation power value detected at the second sampling timing, a correlation power value detected at a third sampling timing that precedes an earlier one of the first sampling timing and the second sampling timing by n sampling intervals, and a correlation power value detected at a fourth sampling timing that follows a later one of the first sampling timing and the second sampling timing by n sampling intervals, where n is a natural number.
